(19) United States
(12) Patent Application Publication
(10) Pub. No.: US 2004/0158450 A1
(43) Pub. Date: Aug. 12, 2004

(54) Solder joint life prediction method

(75) Inventors: Mami Nakadate, Kawasaki (JP); Makoto Sakairi, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 10/769,747

(22) Filed: Feb. 3, 2004

(30) Foreign Application Priority Data
Feb. 5, 2003 (JP) 2003-27836

(51) Int. Cl. G06F 9/45

(52) U.S. Cl. 703/22

(57) ABSTRACT

The present invention relates to a solder joint life prediction method for predicting the joint life of joining solder which joins members with each other. It predicts the life of soldered joints with high accuracy in a short period of time. It observes phase growth in a crack pre-initiation stage, extrapolates the phase growth, and thereby predicts the time of crack initiation when an initial crack will appear in the joining solder. After the crack initiation, the present invention predicts the time of fracture using a simulation in which creep analysis is performed with a virtual initial crack given to data-based joining solder.

### BACKGROUND OF THE INVENTION

1. Field of the Invention

The present invention relates to a solder joint life prediction method for predicting the joint life of joining solder which joins members with each other.

2. Description of the Related Art

With reductions in the size and weight of electronic devices, it has become one of important tasks to ensure fatigue resistance and reliability of soldered joints in electronic devices.

To evaluate the reliability of soldered joints, accelerated heat cycle testing is used conventionally, but the testing requires few months, and with reductions in time-to-market cycles of products, it has become a challenge to reduce the time required for reliability evaluation in the manufacturing phase.

Under these circumstances, studies have been conducted on reliability evaluation of soldered joints and it has been found so far that as phase growth of solder proceeds, cracks develop in the solder. Thus, it has been proposed to evaluate the reliability of soldered joints by observing the phase growth of solder (e.g., Non-Patent Document 1). Also, a technique has been proposed which analyzes crack growth with a virtual initial crack given to a joining solder using a simulation based on a finite element method, calculates a crack growth rate, and thereby predicts the time of fracture (see Non-Patent Document 2 and 3).

[Non-Patent Document 1]

Minoru Mukai, Hiroyuki Takahashi, and Takashi Kawakami (Machinery and System Laboratory Corporate, Research and Development Center, Toshiba Corp.) and Kikuo Minemoto (Department of Engineering at Tokyo Institute of Technology), “Crack Growth Analysis on BGA Solder Bump Connections,” Japan Society of Mechanical Engineers, Collaborating Group, Research Report RC162, Special Interest Group on Reliability Assessment for Electronics Packaging, Chapter 20

[Non-Patent Document 2]

Sayama et al., “Thermal Fatigue Crack Initiation Life Predictions of Welded Joints by Means of Phase Growth Parameters” Japan Society of Mechanical Engineers, 7th Symposium on Microjoining and Assembly Technology in Electronics, 2001, 35-40

[Non-Patent Document 3]

Sayama et al., “Thermal Fatigue Crack Initiation Life Predictions of Welded Joints by Means of Phase Growth Parameters” Japan Society of Mechanical Engineers, 7th Symposium on Microjoining and Assembly Technology in Electronics, 2001, 41-46

However, even if the time point at which a crack is formed is found through observation of the phase growth of solder, crack formation in solder does not lead immediately to solder fracture. Also, even if the time of crack initiation and phase growth are associated precisely, it is difficult to know practical life of the solder.

Also, in the case of a technique for analyzing crack growth through simulation by giving a virtual initial crack to joining solder, soldered joints of electronic devices immediately after production do not contain cracks, and the simulation does not make it possible to accurately tell solder life, i.e., the time until solder fracture.

In this way, there are various techniques for predicting the life of soldered joints. For example, crack growth analysis simulations which allow soldered joints to be evaluated in a short period are sometimes used in the design phase. However, in the manufacturing phase, accelerated heat cycle testing and the like are actually conducted on products for periods as long as several months because conventional life prediction techniques are still not reliable enough.

In view of the above circumstances, the present invention has an object to provide a solder joint life prediction method which can predict the life of soldered joints with high accuracy in a short period of time.

### SUMMARY OF THE INVENTION

To achieve the above object, the present invention provides a solder joint life prediction method for predicting the joint life of joining solder which joins members with each other, including:

a crack initiation prediction step of running a fatigue test on soldered joints, observing phase growth in a crack pre-initiation stage of the joining solder, extrapolating the phase growth, and thereby predicting the time of crack initiation when an initial crack will appear in the joining solder; and

a fracture time calculation step of performing creep analysis by a finite element method with a virtual initial crack given to data-based joining solder, and thereby predicting the time of fracture when the virtual crack grows long enough to be a fracture.

The “finite element method” here is a type of mathematical method for use on a computer to calculate various states in an object, such as deformation patterns, strain distribution, stress distribution, etc. obtained when force is applied to the object. “Creep analysis” is a type of material analysis which studies character of a creep, a phenomenon in which a material deforms gradually with time at a constant temperature and under constant stress.

If a fatigue test such as a heat cycle test is run on soldered joints continuously, cracks are initiated after some time and grow gradually until fracture occurs finally. By paying attention to the process of leading to the fracture, the present invention observes phase growth in a crack pre-initiation stage, extrapolates the phase growth, and thereby predicts the time of crack initiation when an initial crack will appear in the joining solder. After the crack initiation, the present invention predicts the time of fracture using a simulation in which creep analysis is performed with a virtual initial crack given to data-based joining solder.

By making different techniques take charge of their specialties, the present invention can predict solder joint life with high accuracy.

The crack initiation prediction step needs to observe the phase growth only in the crack pre-initiation stage, and the rest of the phase growth can be extrapolated to predict the time of crack initiation. Besides, the fracture time calculation step, which employs a simulation, can be carried out in a short period and even concurrently with the crack initiation prediction step. Thus, solder joint life can be predicted within a month or less whereas conventionally solder joint life is predicted by running a fatigue test such as a heat cycle test continuously until fracture occurs finally.

In the solder joint life prediction method, the fracture time calculation step may involve calculating equivalent non-linear strain amplitude Δε by elasto-plastic creep analysis based on the finite element method with the virtual initial crack given to the data-based joining solder, converting the equivalent non-linear strain amplitude Δε into a crack growth rate by the application of the Coffin-Manson law, and calculating the time of fracture based on the crack growth rate.

Alternatively, the fracture time calculation step may involve calculating an integration interval ΔJc of creep J by elastic creep analysis based on the finite element method with the virtual initial crack given to the data-based joining solder, converting the integration interval ΔJc of the creep J into a crack growth rate, and calculating the time of fracture based on the crack growth rate.

Preferably, the solder joint life prediction method includes an actual measurement step of actually measuring phase growth beforehand at the time when initial cracks appear by running a fatigue test on soldered joints until the initial cracks appear in joining solder, and

the crack initiation prediction step involves running a fatigue test on soldered joints, observing phase growth in a crack pre-initiation stage of the joining solder, extrapolating the phase growth, and predicting the time when the phase growth reaches a level equivalent to the value of the phase growth actually measured at the time when the initial cracks appear in the actual measurement step, as the time of crack initiation.

More preferably, the actual measurement step involves actually measuring the phase growth at the time when the initial cracks appear in the joining solder, continuing the fatigue test even after the initial cracks appear until cracks equivalent to a fracture are formed in the soldered joints, and thereby measuring the time of fracture counting from the time of crack initiation;

the solder joint life prediction method includes a virtual initial crack calculation step of determining the length of the virtual initial crack to be given to the data-based joining solder such that the time of fracture obtained by the same calculation as the one used in the fracture time calculation step will correspond to the actually measured time of fracture in the actual measurement step; and

the fracture time calculation step involves giving the virtual initial crack of the length determined in the virtual initial crack calculation step to the data-based joining solder and performing creep analysis by the finite element method.

In the solder joint life prediction method according to the present invention, the crack initiation prediction step may involve predicting the time of crack initiation by giving a heat cycle test to the soldered joints as the fatigue test, or it may involve predicting the time of crack initiation by giving a mechanical cycle test to the soldered joints as the fatigue test, or it may involve predicting the time of crack initiation by giving a load test at elevated temperature to the soldered joints as the fatigue test.

As described above, the present invention makes it possible to predict the life of soldered joints with high accuracy in a short period of time.

### BRIEF DESCRIPTION OF THE DRAWINGS

FIG. 1 is a diagram showing a process flow of a solder joint life prediction method according to one embodiment;

FIG. 2 is a diagram showing a flow of another fracture time calculation step which can be used instead of the fracture time calculation step in FIG. 1;

FIG. 3 is a diagram showing a shape of a specimen;

FIG. 4 is a diagram showing a shape of a specimen;

FIG. 5 is a diagram showing details of a BGA soldered joint;

Parts (A) and (B) of FIG. 6 are diagrams showing temperature profiles of heat cycle tests;

Parts (A), (B), and (C) of FIG. 7 are diagrams showing examples of images observed in an accelerated heat cycle test;

FIG. 8 is a diagram showing phase growth curves of Sn/Pb solder;

FIG. 9 is a diagram showing phase growth curves of Sn/Ag/Cu solder;

FIG. 10 is a diagram showing an overall analysis model; Parts (A) and (B) of FIG. 11 are diagrams showing a detailed analysis model;

FIG. 12 is a diagram showing results of a rupture test and rupture life prediction;

FIG. 13 is a diagram showing results of a rupture test and rupture life prediction; and

Parts (A) and (B) of FIG. 14 are diagrams showing results of life predictions of Sn/Pb solder using different initial crack lengths.

### DETAILED DESCRIPTION OF THE PREFERRED EMBODIMENTS

An embodiment of the present invention will be described below.

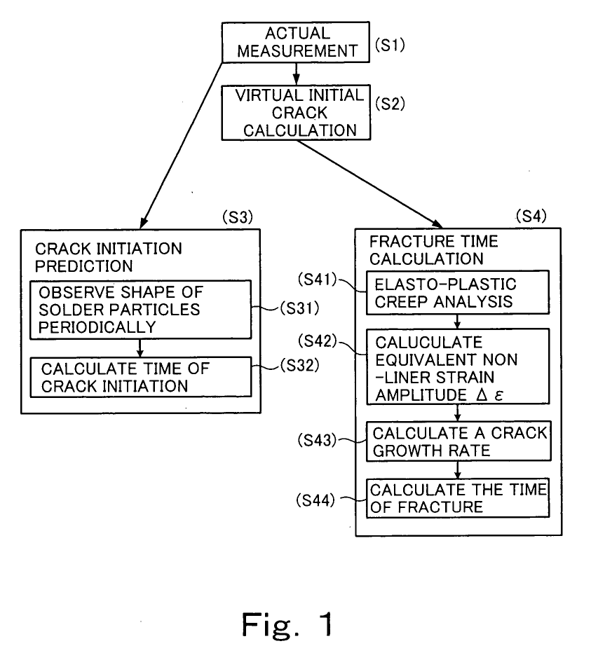

FIG. 1 is a diagram showing a process flow of a solder joint life prediction method according to one embodiment of the present invention.

FIG. 1 shows an actual measurement step (step S), virtual initial crack calculation step (step S2), crack initiation prediction step (step S3), fracture time calculation step (step S4).

The actual measurement step (step S) involves actually measuring phase growth beforehand at the time when initial cracks appear by running a fatigue test on soldered joints until the initial cracks appear in joining solder. According to this embodiment, the actual measurement step involves actually measuring the phase growth at the time when the initial cracks appear in the joining solder, continuing the fatigue test even after the initial cracks appear until cracks equivalent to a fracture are formed in the soldered joints, and thereby measuring the time of fracture counting from the time of crack initiation.

The fatigue test here may be any of the following: a heat cycle test which involves raising and lowering temperature on a regular cycle, mechanical cycle test which involves varying mechanical loading regularly, and load test at elevated temperature which involves keeping a specimen at a predetermined high temperature under load.

The virtual initial crack calculation step (step S2) involves calculating the length of the virtual initial crack to be given to the data-based joining solder such that the time of fracture obtained by the same calculation as the one used in the fracture time calculation step (step S4) described later will correspond to the actually measured time of fracture in the actual measurement step (step S1).

The actual measurement step (step S1) and virtual initial crack calculation step (step S2) are preparatory steps used to collect data for use in the crack initiation prediction step (step S3) and fracture time calculation step (step S4). Once sufficient data has been collected, there is no need to carry out these steps unless the data collected so far becomes insufficient because, for example, a new solder material is used. If the data collected so far can be used, there is no need to repeat the actual measurement step (step S1) and virtual initial crack calculation step (step S2) even if new electronic devices are developed.

In contrast, when a new electronic device is developed, the crack initiation prediction step (step S3) and fracture time calculation step (step S4) must be carried out to determine the solder joint life of the new electronic device.

The crack initiation prediction step (step S3) involves running a fatigue test on soldered joints on electronic circuit boards of the newly developed electronic device, observing phase growth in a crack pre-initiation stage of the joining solder, extrapolating the phase growth, and thereby predicting the time of crack initiation when an initial crack will appear in the joining solder.

The crack initiation prediction step uses the same fatigue test as the actual measurement step (step S1).

In the crack initiation prediction step, some samples of joining solder are extracted periodically—in regular cycles if a heat cycle test or mechanical cycle test is used as the fatigue test or at regular time intervals if a load test at elevated temperature is used as the fatigue test—and the shape of solder particles are observed under an electron microscope to measure the extent of phase growth (step S31). The periodic observations are made long before initial cracks appear in the joining solder.

Then, the phase growth is extrapolated from the stage before the initial cracks appear, and thereby the time of crack initiation (the number of cycles completed before initial cracks appear if a heat cycle test or mechanical cycle test is used as the fatigue test or the time required for initial cracks to appear if a load test at elevated temperature is used as the fatigue test) is calculated (step S32).

In step S32, the time at which the phase growth reaches an actually measured value is calculated as the time of crack initiation by extrapolation with reference to the actually measured value of the phase growth obtained beforehand in the actual measurement step (step S1) when initial cracks appear in the joining solder.

The fracture time calculation step (step S4) involves performing creep analysis by a finite element method with a virtual initial crack given to the data-based joining solder, and thereby predicting the time of fracture when the virtual crack grows long enough to be a fracture. The fracture time calculation step uses the virtual initial crack whose length has been calculated in the virtual initial crack calculation step (step S2) such that the time of fracture will correspond to the time of fracture actually measured in the actual measurement step (step S1). For the sake of simulation operations, the fracture time calculation step (step S4) uses the same fatigue test as the one used in the actual measurement step (step S1) and crack initial prediction step (step S3).

The fracture time calculation step shown in FIG. 1 involves performing elasto-plastic creep analysis based on the finite element method with the virtual initial crack given to the data-based joining solder (step S41), thereby calculating equivalent non-linear strain amplitude Δε (step S42), calculating a crack growth rate from the equivalent non-linear strain amplitude AE by the application of the Coffin-Manson law (step S43), and calculating the time of fracture (the number of cycles until fracture or time until fracture) based on the crack growth rate (step S44).

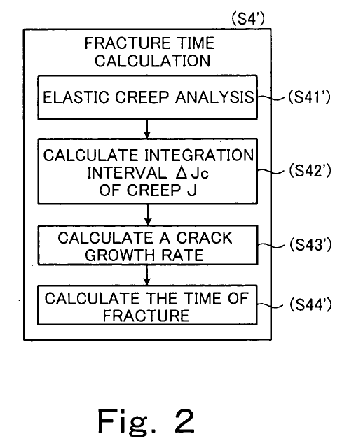

FIG. 2 is a diagram showing a flow of another fracture time calculation step which can be used instead of the fracture time calculation step (step S4) in FIG. 1.

The fracture time calculation step (step S4′) shown in FIG. 2 involves performing elastic creep analysis based on the finite element method with the virtual initial crack given to the data-based joining solder (step S41′), thereby calculating an integration interval ΔJc of creep J (step S42′), converting the integration interval ΔJc of the creep J into a crack growth rate da/dN according to an evaluation formula, for example, described in Non-Patent Document 1 (step S43′):

da/dN=32.1×ΔJc^{1.807,}

and calculating the time of fracture (the number of cycles until fracture or time until fracture) based on the crack growth rate (step S44′).

The fracture time calculation step (step S4′) shown in FIG. 2 may be used instead of the fracture time calculation step (step S4) shown in FIG. 1.

Both the fracture time calculation step (step S4) shown in FIG. 1 and fracture time calculation step (step S4′) shown in FIG. 2, whichever is used, can be carried out concurrently with the crack initiation prediction step (step S3) in FIG. 1 to evaluate solder joint life in a short period of time.

The crack initiation prediction step (step S3) gives an accurate prediction until initial cracks appear. The fracture time calculation step (step S4 or S4′) simulates processes which take place after initial cracks appear and allows accurate simulations if the length of the virtual initial crack is set at an appropriate value. Thus, overall solder joint life can be predicted accurately.

Description will be given below of evaluation tests conducted on a solder joint life in a fracture life prediction technique using heat cycle tests as the fatigue test.

(1) Specimen Shape and Heat Cycle Tests

(1.1) Specimen Shape

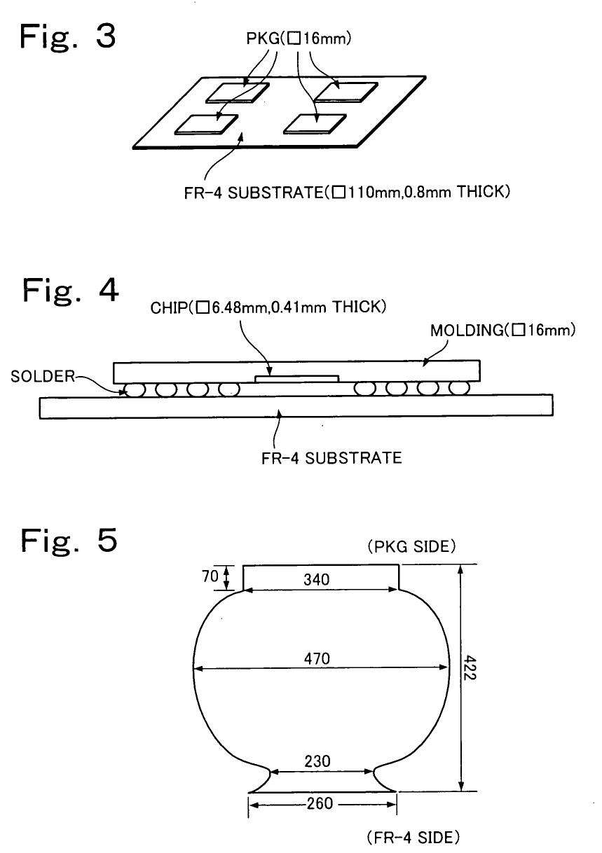

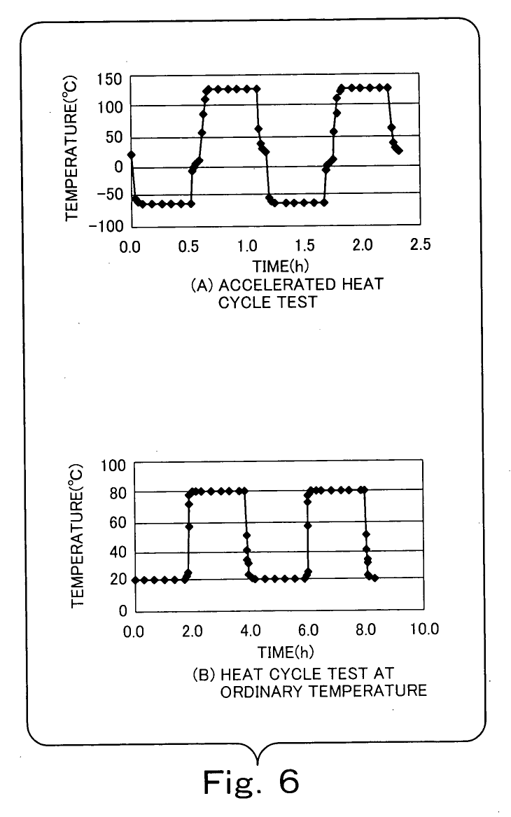

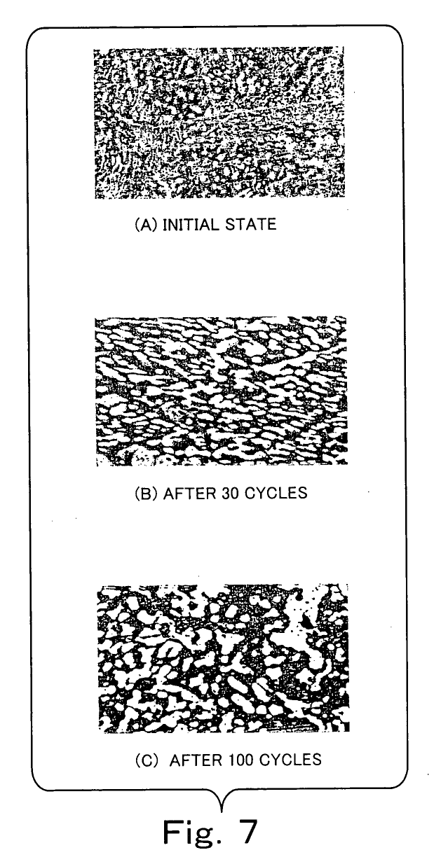

The shape of the specimen used is shown in FIGS. 3 and 4. The specimen consisted of four packages (PKGs) mounted on an FR-4 substrate 110 mm square and 0.8 mm thick. Details of a BGA soldered joint are shown in FIG. 5. The soldered joints were placed at intervals of 0.8 mm in four rows for a total of 224 pins on the peripheries. Two types of solder were used:

(a) Sn/Pb (Pb/63.0 Sn/2.0)

(b) Sn/Ag/Cu (Sn/3.0 Ag/0.7 Cu)

(1.2) Heat Cycle Tests

Two types of heat cycle test were conducted using two temperature ranges: an accelerated heat cycle test which is in general use and heat cycle test at ordinary temperature which was conducted by simulating operating conditions of actual electronic devices. The temperature conditions are shown below. Parts (A) and (B) of FIG. 6 show temperature profiles of the heat cycle tester which was used.

(a) Accelerated heat cycle test: −65° C. (0.5 h) [symbol] 125° C. (0.5 h)

(b) Heat cycle test at ordinary temperature: 20° C. (2.0 h) [symbol] 80° C. (2.0 h)

(2) Crack Initiation Life Prediction Based on Observation of phase growth

Evaluations based on observation of phase growth were made according to the following procedures.

Observe the phase growth of solder structure

Quantify changes in phase growth

Evaluate phase growth and acceleration coefficients

Examine a crack initiation life cycle

(2.1) Observing Solder Structure

The number of sampling cycles used to observe solder structure and thermal fatigue cracking was determined by predicting crack initiation life based on the results of rupture tests on similar packages. Table 1 shows the number of sampling cycles and the number of samples (n) extracted under various conditions. Also, the numbers of sampling cycles used to check for cracks are listed below.

Accelerated heat cycle test (−65° C. [symbol] 125° C.)

\mathring{1} Sn/Pb: 120 cycles

\mathring{2} Sn/Ag/Cu: 400 cycles

Heat cycle test at ordinary temperature (20° C. [symbol] 80° C.)

\mathring{3} Sn/Pb: 70 cycles

\mathring{4} Sn/Ag/Cu: 230 cycles

TABLE 1

| Temperature conditions | Solder | Sampling cycles | n |
|---|---|---|---|
| −65° C. [symbol] 125° C. | Sn/Pb | 30, 60, 100 | 8 |
| | Sn/Ag/Cu | 90, 180, 300 | |
| 20° C. [symbol] 80° C. | Sn/Pb | 100, 150, 200 | |
| | Sn/Ag/Cu | 150, 300, 450 | |

The specimens which underwent the two types of heat cycle test for the prescribed number of cycles had their cross sections ground along package diagonals and their solder structure observed. Soldered joints were observed via reflected electron images under a scanning electron microscope (SEM). The outermost BGAs of the packages in the substrate-side corners where cracks were expected to appear were selected as observing sites based on fracture sites established by experiments on similar packages.

Parts (A), (B), and (C) of FIG. 7 show examples of images observed in an accelerated heat cycle test. Incidentally, solder structure was observed at sites 50 μm inside the substrate-side corners where cracks were expected to appear in soldered joints. The examples in FIG. 7 are images of Sn/Pb solder, where the bright part represents an αPb phase while the dark part represents a βSn phase. Growth in the αPb phase can be observed as the number of heat cycles increases. Also, although not shown in the figure, in the case of Sn/Ag/Cu solder, an Ag₃Sn phase showed up as bright small grains while a βSn phase looked dark. Also, growth was observed in the bright Ag₃Sn phase.

(2.2) Quantifying Changes in Phase Growth

Phase sizes in each cycle were measured using photographed SEM images. For the Sn/Pb solder, average phase size d of the entire structure was calculated and evaluations were made using a phase growth parameter S (see Non-Patent Document 2 and 3 listed earlier) defined by S=d⁴ used for thermal fatigue crack initiation life evaluation of Sn/Pb eutectic solder. On the other hand, the Sn/Ag/Cu solder consists of a βSn phase and Ag₃Sn phase. However, the two phases differ greatly from each other in crystal size, and thus only the Ag₃Sn phase was observed this time because of the ease of observation. Specifically, the average area A of the Ag₃Sn phase was determined and evaluations were made using the phase growth parameter S as was the case with the solder Sn/Pb, but the phase growth parameter S in this case was defined by S=A².

(2.3) Evaluating Phase Growth and Acceleration Coefficients

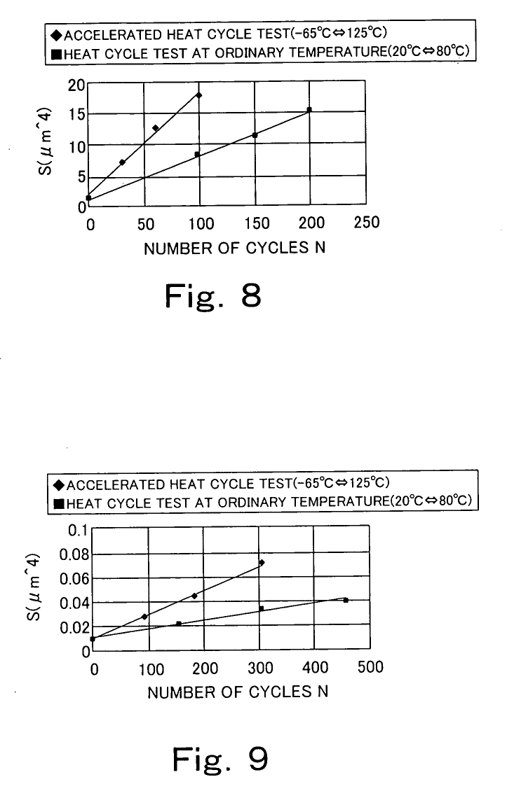

In the heat cycle tests, phase growth curves which represent relationship between the number of cycles N and phase growth parameter S were determined. FIG. 8 shows phase growth curves of the Sn/Pb solder and FIG. 9 shows phase growth curves of the Sn/Ag/Cu solder. It can be seen from the curves that proportionality exists between the number of cycles N and phase growth parameter S. The average increase (ΔS) in S per cycle was determined from the phase growth curve under each condition as follows.

(a) Accelerated heat cycle test

\mathring{1} Sn/Pb: (ΔS)ₐ=1.666E-01 μm⁴

\mathring{2} Sn/Ag/Cu: (ΔS′)ₐ =1.926E-04 μm⁴

(b) Heat cycle test at ordinary temperature

\mathring{3} Sn/Pb: (ΔS)ᵣ=6.629E-02 μm⁴

\mathring{4} Sn/Ag/Cu: (ΔS′)ᵣ=6.458E-05 μm⁴

Next, acceleration coefficients will be estimated from the phase growth curves. An estimation equation for the fatigue crack initiation life of the Sn/Pb solder and Sn/Ag/Cu solder using AS is shown below.

[Formula 1]

ΔS=A×N−β (1)

where A and βare constants characteristic of a solder material. The fatigue crack initiation life of the Sn/Pb solder and Sn/Ag/Cu solder in each heat cycle is expressed as follows.

[Formula 2]

(ΔS)ₐ =A×Nₐ^{-β}, (ΔS′)ₐ =A×N′ₐ^{-β} (2)

[Formula 3]

(ΔS)ᵣ A×Nᵣ^{-β}, (ΔS′)ᵣ=A×N′ᵣ^{-β} (3)

where Nₐ, N′ₐ, Nᵣ, and N′ᵣ are the numbers of cycles which were completed when fatigue cracks occurred in the accelerated heat cycle test and the heat cycle test at ordinary temperature. Furthermore, acceleration coefficients C and C′ of the Sn/Pb solder and Sn/Ag/Cu solder, defined as C=Nₐ/N′ₐ and C′=Nᵣ/N′ᵣ, respectively, are given by the following formulas.

[Formula 4]

C=[(ΔS)ₐ/(ΔS)ᵣ]^{(1/β)} (4)

[Formula 5]

C′=[(ΔS′)ₐ/(ΔS′)ᵣ]^{(1/β)} (5)

Assuming β of the Sn/Pb solder and β′ of the Sn/Ag/Cu solder to be β=0.538 and β′=0.54 and using (ΔS)ₐ, (ΔS)ᵣ, (ΔS′)ₐ, (ΔS′)ᵣ, the acceleration coefficients are given as follows.

Sn/Pb solder: C=5.54

Sn/Ag/Cu solder: C′=7.57

(2.4) Examining Crack Initiation Life

Table 2 shows the number of samples in which cracks were detected out of the samples extracted to predict crack formation in the Sn/Pb solder and Sn/Ag/Cu solder. Regarding the heat cycle test of the Sn/Ag/Cu solder at ordinary temperature, since the experiment has not progressed to where cracks appear, the appropriate fields in the table are left blank. The formation of fatigue cracks is defined as existence of a crack 10 μm or larger when a cross section of a corner bump of the solder is observed. Crack formation was observed both in the Sn/Pb solder and Sn/Ag/Cu solder.

TABLE 2

| | | Samples | Maximum | |
|---|---|---|---|---|
| | Heat cycle test | with | crack | Sampling |
| Solder | conditions | cracks | length | cycles |
| Sn/Pb | −65° C. [symbol] 125° C. | 2/8 | 17 μm | 120 |
| | 20° C. [symbol] 80° C. | 2/8 | 20 μm | 700 |
| Sn/Ag/Cu | −65° C. [symbol] 125° C. | 6/8 | 50 μm | 400 |
| | 20° C. [symbol] 80° C. | | | |

Now, crack initiation life estimated based on formulas (2) to (5) will be compared with the actually measured values. In the case of the Sn/Pb solder, assuming that Nₐ=100 to 150 cycles, it can be estimated that Nᵣ=554 to 831 cycles. Comparing this value with the actually measured value, since cracks were observed in two samples out of eight samples when N=700 cycles was completed, it can be said that the estimated value of Nᵣ=554 to 831 cycles is almost appropriate. In the case of the Sn/Ag/Cu solder, assuming that N′ₐ=300 to 400 cycles, it can be estimated that N′ᵣ=2270 to 3030 cycles. This value will be compared with actually measured values when results of the heat cycle test at ordinary temperature are obtained.

(3) Crack Growth Analysis

(3.1) Analytical Models

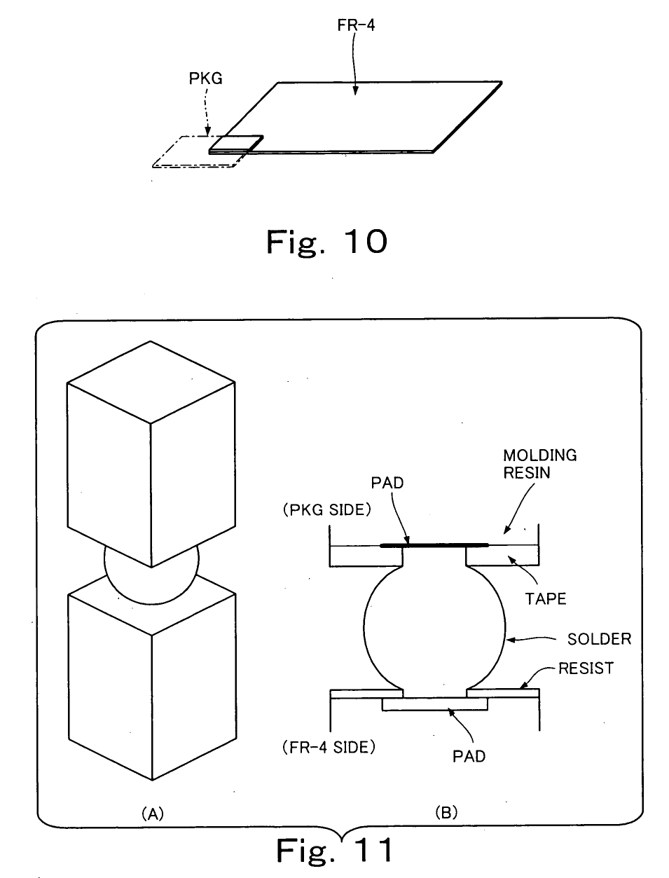

Analytical models of a package were created. Considering symmetry with respect to the substrate, two types of analytical model were created: ¼ scale overall models and detailed models of one solder bump. Then, analysis was conducted in two stages: overall analysis and detailed analysis. FIGS. 10 and 11 show an overall analysis model and detailed analysis model. For crack growth analysis, a detailed analysis model was created with a virtual crack formed around the substrate-side constriction of the solder where non-linear strain amplitudes were concentrated. In so doing, the length of the crack was set to 50 μm to evaluate the growth rate at intervals of 50 μm. Incidentally, the detailed model was created with a minimum mesh size of 12.5 μm.

(3.2) Thermal Fatigue Life Analysis

Table 3 shows part of the property values used for analysis. 3D elasto-plastic creep analysis was conducted using general-purpose Abaqus structural analysis code to determine non-linear strain amplitudes. First, analysis was conducted using the overall analysis models and then, based on boundary conditions obtained as a result, analysis was conducted using two types (a model with a virtual crack and model without a virtual crack) of detailed model of one corner bump in which cracks had been observed in a similar package.

TABLE 3

| | Young's modulus | Poisson's | Linear expansivity |
|---|---|---|---|
| Material | (Mpa) | ratio | (ppm/° C.) |
| Substrate | 14220.0 | 0.2 | 17.6 |
| Chip | 188275.2 | 0.3 | 3.59 |
| Molding resin | 18300.0 | 0.3 | 12.0 |
| Tape | 3598.8 | 0.3 | 20.0 |
| Resist | 2746.0 | 0.3 | 55.0 |

In the detailed analysis, maximum non-linear strain amplitudes were observed in the two types of solder—Sn/Pb and Sn/Ag/Cu—under all the temperature conditions. The results of the analysis coincided with the crack locations observed in the experiment.

(3.3) Crack Growth Evaluation

It is known that thermal fatigue rupture life N_{f} of soldered joints of eutectic solder and the like can be evaluated by the Coffin-Manson law given by formula (6) (e.g., Qiang Yu and Masaki SHIRATORI, “Thermal Fatigue Reliability Assessment for Solder Joints of BGA Assembly,” ASME Advances in Electronic Packaging 1999, EEP vol. 26-1, 239-24).

N_{f}=B×Δεⁿ (6)

where B and n are fatigue strength characteristics of soldered joints. For crack growth analysis, it is necessary to prepare a Coffin-Manson equation for defining crack initiation life Nᵢ. The following slope of rupture life was used as the slope of an evaluation formula (Nishimura et al., “Analysis on Life of Lead-Free Solder in BGAs,” Journal of the Japan Institute of Electronics Packaging, Vol. 4, No. 5 (2001), 416-419).

Sn/Pb:N_{f}=24.5Δε^{-0.786} (7)

Sn/Ag/Cu:N_{f}=31.0Δε^{-0.674} (8)

For the sake of crack growth evaluation, the crack initiation life Nᵢ was defined as the number of cycles completed when the maximum crack length in Table 2 reached 50 μm. Crack growth was evaluated in the experimented Sn/Pb and Sn/Ag/Cu solders only under the temperature condition of −65° C. to 125° C. The crack initiation life of the solders evaluated is shown below.

Crack Initiation Life

Sn/Pb: 353.44 CYCLES

(Relationship between crack length and cycles was linearly approximated)

Sn/Ag/Cu: 400 cycles

The crack growth was evaluated by the application of a cumulative damage rule based on the above results. The number of cycles completed until cracks resulted in fracture (230 μm) was determined.

(4) Comparison of Rupture Life Cycles

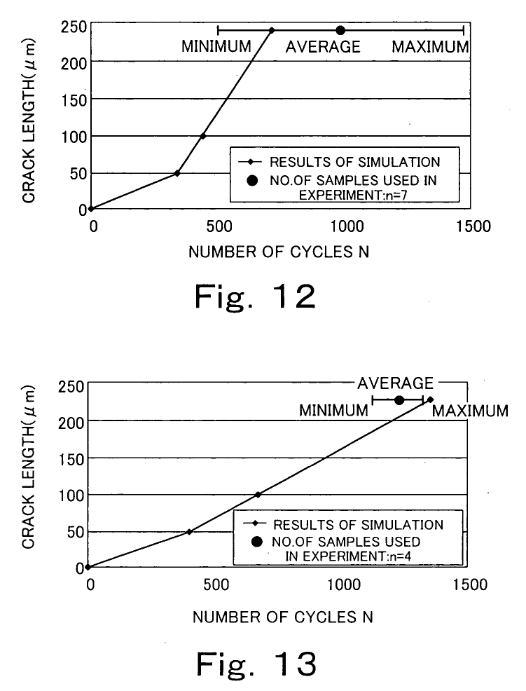

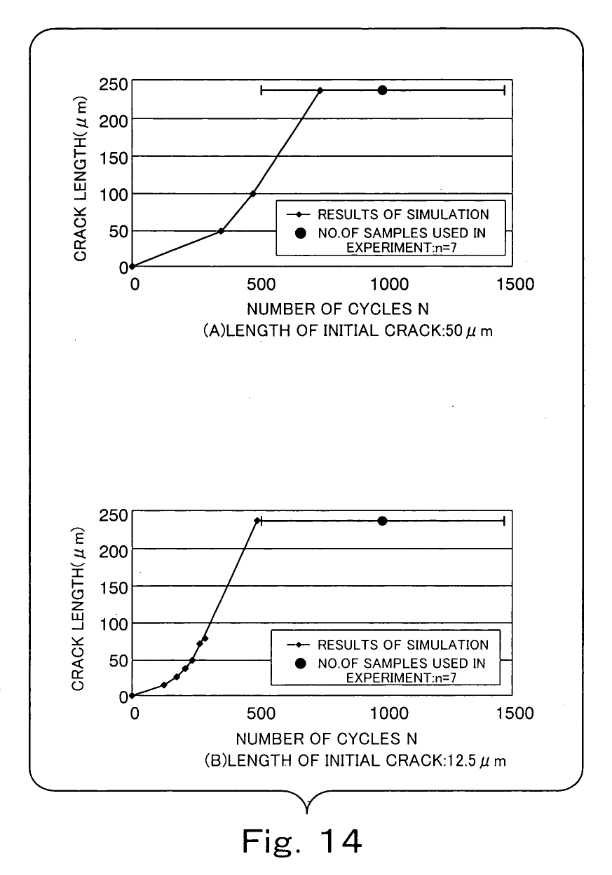

Rupture life cycles obtained as a result of rupture tests and rupture life evaluated by the present technique are shown in FIGS. 12 and 13. The crack growth rate up until fracture was extrapolated from the crack growth rate for the crack length of 50 μm to 100 μm.

Minimum, Average, and Maximum along the horizontal line represent variation in the number of cycles completed when fracture occurred in the experiment. That is, they represent the minimum number of cycles, average number of cycles, and maximum number of cycles.

Regarding the Sn/Pb solder, the rupture life predicted by the present technique was shorter than the average rupture life measured actually. In view of the fact that the evaluation made this time fell within the variation and predicted the shortest life, it can be said that the prediction was made within appropriate tolerances. In the case of the Sn/Ag/Cu solder shown in FIG. 13, the rupture life predicted by the present technique was slightly longer than the average rupture life measured actually. Although the predicted value deviates slightly from the range of actually measured values it is believed that this may be attributable to the fact the number n of samples was as small as 4 except for boundary fracture samples. Thus, it was found that predictions can be made within appropriate tolerances also in the case of the Sn/Ag/Cu solder.

Parts (A) and (B) of FIG. 14 show results of life evaluations of Sn/Pb solder using different initial crack lengths.

Life was evaluated to be shorter when the virtual initial crack was 12.5 μm (B) than when it was 50 μm (A). By adjusting the length of the virtual initial crack in this way, it is possible to obtain evaluation results which correspond to experimental results (actual measurement step S1 in FIG. 1).

Next, description will be given of the period required for evaluation in heat cycle tests.

Conventionally, it takes two to three months to judge rupture life by actually conducting a heat cycle test. For example, when repeating 1500 or more cycles under a temperature condition of −65° C. to 125° C., if the retention time at −65° C. is 30 minutes, the retention time at 125° C. is 30 minutes, the transition time is 5 minutes (see Part (A) of FIG. 6), one cycle is 70 minutes (including defrosting at subzero temperatures), and the number of cycles repeated per day is 19, the time requires is as follows:

1500 cycles ÷19=79 cycles =2.6 months

In contrast, when the present evaluation technique is used, if observation of phase growth takes 1.5 weeks (approximately 5 days for 30, 60, and 90 cycles at −65° C. to 125° C.; 3 days for observation under an electron microscope; and 3 days for organization of data) and crack growth analysis takes 2 weeks (3 to 5 days for modeling, 3 to 5 days for calculation and 1 day for organization of data), life evaluation takes only 0.8 month even if phase growth observation and crack growth analysis are carried out on different schedules.

Thus, the present technique allows to make life evaluation in a shorter period than conventional techniques.

What is claimed is:

1. A solder joint life prediction method for predicting the joint life of joining solder which joins members with each other, comprising:
a crack initiation prediction step of running a fatigue test on soldered joints, observing phase growth in a crack pre-initiation stage of the joining solder, extrapolating the phase growth, and thereby predicting the time of crack initiation when an initial crack will appear in the joining solder; and
a fracture time calculation step of performing creep analysis by a finite element method with a virtual initial crack given to data-based joining solder, and thereby predicting the time of fracture when the virtual crack grows long enough to be a fracture.

2. The solder joint life prediction method according to claim 1, wherein the fracture time calculation step involves calculating equivalent non-linear strain amplitude Δε by elasto-plastic creep analysis based on the finite element method with the virtual initial crack given to the data-based joining solder, converting the equivalent non-linear strain amplitude Δε into a crack growth rate by the application of the Coffin-Manson law, and calculating the time of fracture based on the crack growth rate.

3. The solder joint life prediction method according to claim 1, wherein the fracture time calculation step involves calculating an integration interval ΔJc of creep J by elastic creep analysis based on the finite element method with the virtual initial crack given to the data-based joining solder, converting the integration interval ΔJc of the creep J into a crack growth rate, and calculating the time of fracture based on the crack growth rate.

4. The solder joint life prediction method according to claim 1, comprising:
an actual measurement step of actually measuring phase growth beforehand at the time when initial cracks appear by running a fatigue test on soldered joints until the initial cracks appear in joining solder,
wherein the crack initiation prediction step involves running a fatigue test on soldered joints, observing phase growth in a crack pre-initiation stage of the joining solder, extrapolating the phase growth, and predicting the time when the phase growth reaches a level equivalent to the value of the phase growth actually measured at the time when the initial cracks appear in the actual measurement step, as the time of crack initiation.

5. The solder joint life prediction method according to claim 4, wherein:
the actual measurement step involves actually measuring the phase growth at the time when the initial cracks appear in the joining solder, continuing the fatigue test even after the initial cracks appear until cracks equivalent to a fracture are formed in the soldered joints, and thereby measuring the time of fracture counting from the time of crack initiation;
the solder joint life prediction method comprises a virtual initial crack calculation step of determining the length of the virtual initial crack to be given to the data-based joining solder such that the time of fracture obtained by the same calculation as the one used in the fracture time calculation step will correspond to the actually measured time of fracture in the actual measurement step; and
the fracture time calculation step involves giving the virtual initial crack of the length determined in the virtual initial crack calculation step to the data-based joining solder and performing creep analysis by the finite element method.

6. The solder joint life prediction method according to claim 1, wherein the crack initiation prediction step involves predicting the time of crack initiation by giving a heat cycle test to the soldered joints as the fatigue test.

7. The solder joint life prediction method according to claim 1, wherein the crack initiation prediction step involves predicting the time of crack initiation by giving a mechanical cycle test to the soldered joints as the fatigue test.

8. The solder joint life prediction method according to claim 1, wherein the crack initiation prediction step involves predicting the time of crack initiation by giving a load test at elevated temperature to the soldered joints as the fatigue test.
